(19) United States
(12) Patent Application Publication
(10) Pub. No.: US 2026/0184984 A1
(43) Pub. Date: Jul. 2, 2026

(54) MICROEMULSION COMPOSITIONS FOR ENHANCED ACIDIZING OF OIL AND GAS WELLS

(71) Applicant: Locus Solutions IPCo, LLC, Solon, OH (US)

(72) Inventors: Megan R. PEARL, Solon, OH (US); Erna KAKADJIAN, Solon, OH (US); Hin Cheong Au YONG, Solon, OH (US); Amir MAHMOUDKHANI, Solon, OH (US)

(21) Appl. No.: 18/834,275

(22) PCT Filed: Jul. 11, 2024
(86) PCT No.: PCT/US2024/037590

§ 371 Date: Jul. 30, 2024

Related U.S. Application Data
(60) Provisional application No. 63/513,025, filed on Jul. 11, 2023.

(51) Int. Cl. C09K 8/584; C09K 8/54; E21B 41/02; E21B 43/20; E21B 43/24; E21B 43/27

(52) U.S. Cl. CPC C09K 8/584; C09K 8/54; E21B 43/27; C09K 2208/32; E21B 41/02; E21B 43/20; E21B 43/24

(57) ABSTRACT

The subject invention provides compositions and methods for improved acidizing treatments in oil and gas wells, as well as for enhancing oil recovery. Advantageously, the invention utilizes naturally-derived ingredients to replace and/or reduce chemical acidizing additives in order to simplify acidizing jobs, reduce logistics and improve efficiency. Furthermore, the invention allows for acidizing additives that are typically incompatible to be combined into a stable formulation without high energy input and with reduced need for on-site preparation.

### CROSS-REFERENCE TO RELATED APPLICATION

This application claims priority to U.S. Provisional Patent Application No. 63/513,025, filed Jul. 11, 2023, which is incorporated by reference herein in its entirety.

### BACKGROUND OF THE INVENTION

Subterranean oil containing formations penetrated by well bores are often treated with aqueous acids to stimulate the production of oil. One such treatment generally referred to as “acidizing” involves the introduction of an aqueous acid solution into a subterranean formation under pressure so that the acid solution flows through the pore spaces of the formation. The acids used in acidizing treatments can include, mineral acids, such as hydrochloric acid (HCl), hydrofluoric acid (HF) and mixtures thereof called mud acid, and organic acids, such as acetic acid.

Acidizing treatments are typically performed to increase permeability of oil and gas formations, dissolve mineral deposits and to remove various types of damage therein. A major function of an acidizing formulation is to remove damage by dissolving scale and formation fines and to stimulate the formation, as well as to serve as a pre-flush treatment for treatments such as gas injection, chemical flooding or acid matrix stimulation treatments.

Another production stimulation treatment known as “fracture-acidizing” involves the formation of one or more fractures in the formation and the introduction of an aqueous acid solution into the fractures to etch the fracture faces, forming channels therein when the fractures close. The acid also enlarges the pore spaces in the fracture faces and in the formation.

Acidizing and fracture-acidizing solutions typically contain from about 10% to about 30% acid, which causes corrosion of metal surfaces in pumps, tubular goods and equipment used to introduce the aqueous acid solutions into the treated formation. Thus, anti-corrosive additives are typically added to the fluid to protect metal surfaces of wellbore tubulars and other equipment from corrosive attack.

Further, other additives may be added to the acidizing formulation to improve injectivity and return of the stimulation fluids. Other additives may include wetting agents, foaming agents, silt-suspending agents, anti-sludging agents, iron-control additives such as reducing or chelating agents, non-emulsifiers or emulsifiers depending upon the formulation and mutual solvents.

Additives may be more or less soluble or dispersible in the aqueous acid solutions used for acidizing and thus may precipitate out or phase separate into an oil phase in the formation. Further, the products of the acidizing treatment may precipitate out or form sludges in the formation creating additional formation damage.

It is a standard industry practice to mix the formulation ingredients together immediately prior to injection or within 24-48 hours prior to injection due to the industry recognized instability of conventional acidizing formulations. Most often, separate ingredients are shipped to the wellsite and the ingredients mixed together only as required and at the time required.

Accordingly, compositions and methods are needed for improved, simplified acidizing treatments, particularly treatments that can be pre-mixed to reduce the time and cost of on-site preparation.

### BRIEF SUMMARY OF THE INVENTION

The subject invention provides compositions and methods for improved acidizing treatments in oil and gas wells, as well as for enhancing oil recovery. Advantageously, the invention utilizes naturally-derived ingredients to replace and/or reduce chemical acidizing additives in order to simplify acidizing jobs, reduce logistics and improve efficiency. Furthermore, the invention allows for acidizing additives that are typically incompatible to be combined into a stable formulation without high energy input and with reduced need for on-site preparation.

The compositions and methods can remove oil, inorganic and organic deposits on the reservoir face, preparing it for acidizing and increasing the kinetics and effectiveness of an acid treatment. Additionally, the compositions and methods of the subject invention can be used to enhance oil recovery by dissolving rock (e.g., sandstone and/or carbonate rock) within a reservoir to improve porosity and permeability, and ultimately improve and/or stimulate the flow of oil.

In preferred embodiments, the subject invention provides an improved acidizing composition, wherein the composition comprises a biosurfactant-based additive. In some embodiments, the biosurfactant is used to produce a stable microemulsion with one or more other acidizing additives, wherein the microemulsion can be pre-mixed and stored and/or transported for an extended of time prior to delivery to an oilfield for application.

The composition can be directly combined with the acid in a single-stage application and can replace additional surfactants and solvents typically delivered in a separate stage from the acid or combined in the acid stage.

In certain embodiments, the biosurfactant-based additive comprises an isolated and/or purified biosurfactant, while in other embodiments, the biosurfactant is utilized in crude form comprising microbial cells, fermentation broth and/or nutrients that are residual from fermentation. If present, the microbial cells are preferably inactivated prior to use by, for example, heat inactivation.

In some embodiments, a blend of biosurfactants is used. Biosurfactants useful according to the subject invention include, for example, glycolipids, lipopeptides, fatty acid esters, fatty acid ethers, flavolipids, phospholipids, lipoproteins, lipopolysaccharide-protein complexes, and/or polysaccharide-protein-fatty acid complexes.

In one embodiment, the biosurfactants are glycolipids, for example, rhamnolipids (RLP), rhamnose-d-phospholipids, trehalose lipids, trehalose dimycolates, trehalose monomycolates, mannosylerythritol lipids (MEL), cellobiose lipids, ustilagic acids and/or sophorolipids (SLP) (including lactonic forms and/or linear forms); and/or lipopeptides, such as, for example, surfactin, iturin, fengycin, arthrofactin, viscosin, amphisin, syringomycin, and/or lichenysin.

In certain preferred embodiments, the biosurfactant is a sophorolipid (SLP). SLP can be produced by fermentation of a yeast such as, for example, Starmerella bombicola, in the presence of a hydrocarbon-based source of one or more fatty acids. The composition can include more than one form of SLP, including, e.g., linear SLP and lactonic SLP. The SLP can be non-acetylated, mono-acetylated and/or di-acetylated SLP. The SLP can further be derivatized to include, e.g., sulfonate groups, amino acid groups, ester groups, or other additions.

In addition to a biosurfactant or a blend of biosurfactants, the composition can comprise one or more other acidizing additives. These can include, for example, solvents, surfactants, chelators, corrosion inhibitors, and various polar and non-polar fluids.

The composition may be a single phase formulation or a multi-phase formulation. The multiple phase composition may include a polar phase, a non-polar phase, and at least one surfactant (e.g., a biosurfactant).

Some or all of the additives can be blended with the biosurfactant in the form of a microemulsion. In some embodiments, however, some or all of the additives can be administered separately and/or mixed immediately (e.g., within 24 hours) prior to administration down an oil well.

In certain embodiments, the composition comprises one or more acids such as, for example, hydrofluoric acid, hydrochloric acid, citric acid or acetic acid. The one or more acids are preferably present, either individually or combined, at about 0.001% to 75%, about 0.1% to 50%, or about 1% to 30% with respect to the total composition (v/v or wt %).

In certain embodiments, the use of a biosurfactant in the composition can reduce and/or replace traditional solvents and/or surfactants used in acidizing formulations; however, in some embodiments, the compositions can still comprise these components.

For example, in certain embodiments, the composition comprises one or more polar or non-polar fluids, including solvents and/or carriers such as mutual solvents, glycol ethers, terpenes, terpenoids, acetates, alcohols, kerosene, gasoline, diesel, benzene, toluene, hexane naphtha, cumene, pseudocumene, xylene, water, and/or brine. The one or more solvents and/or carriers are preferably present, either individually or combined, at about 0.001% to 75%, about 0.1 to 50%, or about 1.0 to 45% with respect to the total composition (v/v or wt %).

Additionally in certain embodiments, the composition can comprise one or more secondary surfactants. The surfactant(s) can be of non-biological origin and/or they can be biosurfactants, meaning surfactants produced by a living cell and/or using naturally-derived substrates. Surfactants can be, for example, anionic, cationic, zwitterionic and/or nonionic.

In an exemplary embodiment, the secondary surfactants comprise ethoxylated C12-C16 alcohols, alkylpolyglucosides, sulfonates, disodium oxybis(decylbenzenesulphonate), isopropanolamine dodecylbenzene sulfonate (or the acid form, DDBSA), disodium decyl(sulfonatophenoxy)benzenesulfonate, polyethylene glycol undecyl ether, propylene glycol, cocamide diethanolamine, and/or commercial surfactant blends. The one or more surfactants are preferably present, either individually or combined, at about 0.1 to 65%, or about 1 to 55% with respect to the total composition (v/v or wt %).

In one embodiment, the composition further comprises one or more corrosion inhibitors such as, for example, acetylenic alcohols, such as propargyl alcohol organic amines; dimer/trimer acids derived from tall oil or other bases; quaternary amines derived from coconut, canola, tallow, tall oil or other bases; fatty alcohols; derivatized quinolines; alkyl pyridines; and oxyalkylated resin amines. The one or more corrosion inhibitors are preferably present, either individually or combined, at about 0.001 to 50%, about 0.1 to 25%, or about 1 to 10% with respect to the total composition (v/v or wt %).

Surprisingly, though iron chelators are typically required additives in any acidizing treatment, embodiments of the the subject composition can perform the function of iron chelator without addition of a standard iron chelator. Nonetheless, in one embodiment, the composition further comprises one or more chelating agents such as, for example, EDTA (ethylenediamine tetraacetic acid), disodium EDTA, HEDTA (hydroxyethylenediamine triacetic acid), nitrilioacetic acid (NTA), erythorbic acid, citric acid, citrate, sodium acetate, glycolic acid, thioglycolic acid, 2-mercaptoethanol, thioglycerol, hypophosphorous acid, inorganics (e.g., copper, antimony, bismuth, iodide) quaternary ammonium compounds, 2-mercaptoethanol, stannous chloride or a mixture of any of these. The one or more chelating agents are preferably present, in total, at about 0.001 to 75%, about 0.1 to 50%, or about 1 to 25% with respect to the total composition (v/v or wt %).

The subject composition can further comprise carriers (e.g., water, oil and/or brine fluids) as well as other additives that are useful for acidizing and fracture acidizing, including, for example, mutual solvents, co-solvents, co-surfactants, wetting agents, foaming agents, silt-suspending agents, anti-sludging agents, proppants, viscosity modifiers, emulsifiers and enzymes. Brine fluids can comprise salts such as, for example, ammonium chloride, sodium chloride, potassium chloride, and/or combinations thereof. These additional compounds can be added at concentrations ranging from, for example, about 0.001% to 50%, about 1% to 25%, or about 10%, by weight or volume of the total composition.

In preferred embodiments, the biosurfactant according to the subject invention is utilized in formulating the composition into a stable microemulsion. Microemulsions are thermodynamically stable fluid dispersions of two or more immiscible liquids, such as oil and water. Microemulsions form when a surfactant, or more commonly a mixture of surfactants and co-surfactants, lowers the oil/water interfacial tension to ultra-low values (e.g., less than 0.001 dynes/cm), allowing thermal motions to spontaneously disperse the two immiscible phases. Techniques for forming microemulsions are known in the art.

Advantageously, when formulated as a microemulsion, the compositions of the subject invention are shelf stable for at least one week or longer, and can be transported, stored and then applied selectively to an oil well at any point, for example, after a decline in production is observed.

The subject invention further provides methods for enhancing oil recovery from an oil-bearing formation wherein an acidizing composition according to the subject invention is applied to an oil well associated with the formation.

In some embodiments, the methods improve the efficiency of oil and/or gas recovery by, e.g., decreasing the amount of resources and energy required to recover oil and/or gas from a formation, and in general, increasing the amount of oil and/or gas recovered over a certain period of time. Furthermore, the methods can decrease the amount of steps and energy required for acidizing treatments, thereby providing for simplified methods of increasing the porosity and permeability of a formation.

The compositions and methods can be utilized in matrix acidizing, fracture acidizing and acid washing. The compositions and methods can also be utilized as a pre-flush treatment to, e.g., dissolve and minimize precipitation of calcareous material; to dissolve iron scale and avoid the precipitation of ferric hydroxide; to displace reservoir brine from the near wellbore area to avoid adverse interactions with chemical flooding solutions; to adjust reservoir salinity to favorable conditions; to prevent the production of high viscosity stable combinations with in situ fluids, such as sludges, emulsions and organic precipitations; and/or to remove deposits, such as paraffin, asphaltene and scale, from oil- and/or natural gas-bearing formations, and/or the wells and production equipment associated therewith.

Even further, in addition to ultimately increasing the amounts of crude oil recovered from a well due to the opening and/or enlarging of formation rock pores and/or causing the formation of fractures, the methods also enhance oil recovery through, for example, the amphiphilic properties of surfactants, including biosurfactants. The use of biosurfactants in oil recovery can effectively alter the wettability of formation rock and decrease the surface/interfacial tension downhole, thereby facilitating the flow of oil from the formation.

The subject invention can be used in, for example, vertical, horizontal and/or fracking wells, mature wells, depleted (marginal) wells, flowlines, to clean near wellbore zones and to clean storage tanks.

In one embodiment, the subject compositions and methods can be used without releasing large quantities of inorganic compounds into the environment. Additionally, the compositions and methods can utilize components, such as biosurfactants, that are biodegradable and toxicologically safe. Thus, while the subject invention can utilize non-biological or synthetic chemical components, the present invention can also be formulated as an environmentally-friendly treatment.

### BRIEF DESCRIPTION OF THE DRAWINGS

FIG. 1 shows a comparison of the reduction in surface tension of water between a microemulsion composition according to an embodiment of the subject invention and industry surfactants.

FIG. 2 shows a comparison of the reduction in interfacial tension of California crude oil in 15% HCl between a microemulsion composition according to an embodiment of the subject invention and industry surfactants.

FIG. 3 shows a comparison of the increase in contact angle reduction between a microemulsion composition according to an embodiment of the subject invention and industry surfactants.

FIG. 4 shows a visual comparison of surfactant properties between a micro emulsion composition according to an embodiment of the subject invention with 1.5% HCl compared to acid alone and acid combined with industry surfactants.

### DETAILED DESCRIPTION

The subject invention provides compositions and methods for improved acidizing treatments in oil and gas wells, as well as for enhancing oil recovery. The compositions and methods of the subject invention can be used to enhance oil recovery by dissolving rock (e.g., sandstone and/or carbonate rock) within a reservoir to improve porosity and permeability, and ultimately improve and/or stimulate the flow of oil.

The subject methods can also be useful for a multitude of other benefits related to oil and gas recovery, including, for example: stimulation of the flow of oil from a formation; removal and inhibition of deposits such as scale, paraffin, and asphaltene; inhibition of bacterial growth and disruption of biofilm formation on equipment; protection against microbial induced corrosion (MIC) and/or acid corrosion; inhibition of high viscosity sludges, emulsions and other organic precipitations; alteration of the wettability of the near-wellbore surface to water-wet; and remediation of formation skin damage.

### Selected Definitions

As used herein, “matrix acidizing” refers to a process in which acid-containing fluids are pumped into a well to dissolve sediment and mud solids, thereby increasing the permeability of the formation rock, enlarging the natural rock pores and stimulating the flow of oil and gas. In matrix acidizing, pumping pressure is typically below the formation pressure.

As used herein, “fracture acidizing” refers to a process in which acid-containing fluids are pumped into a well at pressures above that which will fracture the formation. There are two general types of fracture acidizing. The first type is performed as a preliminary step in a hydraulic fracturing operation, such as in shale or extremely low permeability sandstone or carbonate formations. In this case, acid is pumped ahead of the fluid carrying the proppant that will hold the fractures open once the pump pressure is released. The purpose of the acid job in this case is to provide the cleanest possible formation face to enable easier fracture creation and maximize the performance of the proppant once it is placed. The second type is a fracture acid job, primarily applicable in carbonate formations, where the acid is pumped alone or following a fracturing fluid stage. The intent is to create new fractures or open existing fractures and to dissolve formation material in order to create new flow paths or enhance existing flow paths into the wellbore.

As used herein, “acid washing” refers to a process in which acid-containing fluids are pumped into tubulars and wellbores for cleaning. Treatment of the formation is not necessarily intended. Acid washing is most commonly performed to clean out scale (such as, e.g., calcium carbonate), rust, and other debris restricting flow in the well.

As used herein, “permeability” of a porous rock formation is the measure of the ability of fluid to pass through the rock. Permeability is measured in darcies (D), wherein 1 D is the permeability of a porous medium with a cross-sectional area of 1 cm² and a length of 1 cm, through which the passage of 1 cm³ of fluid with viscosity of 1 cp, flows in 1 second under a pressure differential of 1 atm. Permeability depends upon the porosity of a formation (the higher the porosity the higher the permeability) and the connectivity of the pore spaces. The size and shape of grains, the grain size distribution, and other factors such as the wetting properties of the rock and the presence of pore-blocking deposits can also influence permeability. Permeability can vary from 1 nanodarcy (nD) to 1 microdarcy (mD) for granites, shales and clays, to several D for extremely permeable reservoir rocks. Reservoir permeability can be classified as low or fair (<10 mD), high (10-100 mD), very high (100-1,000 mD), and exceptional (>1,000 mD), where rock with permeability of 1 mD or less is not considered reservoir rock unless subjected to manipulation (e.g., through fracking).

As used herein, “contaminant” refers to any substance that causes another substance or object to become fouled or impure. Contaminants can be living or non-living and can be inorganic or organic substances and/or deposits. Furthermore, contaminants can include, but are not limited to, hydrocarbons, such as petroleum, tar sands or asphaltenes; fats, oils and greases (FOG), such as cooking grease and lard; lipids; waxes, such as paraffin; resins; biofilms; or any other substances referred to as, for example, dirt, dust, salt, scale (including, e.g., calcium carbonate, calcium chloride, barium carbonate, barium chloride, and iron sulfide), sludge, crud, slag, grime, scum, plaque, buildup, or residue.

As used herein, “removal” as used in the context of contaminants or fouling means elimination or reduction of contaminants from a surface, a space, a fluid or a piece of equipment. Removal can include purifying, defouling, decontaminating, clearing or unclogging, and can be achieved by any means, including but not limited to, liquefying, dissolving, melting, dispersing, emulsifying, scraping, degrading, blasting, soaking, or cleaving the contaminant. Furthermore, removal can be total or partial.

As used herein, “prevention” means avoiding, delaying, forestalling, inhibiting or minimizing the onset or progression of an occurrence or situation. Prevention can include, but does not require, absolute or complete prevention, meaning the occurrence or situation may still develop, but at a later time than it would without preventative measures. Prevention can also include reducing the severity and/or extensiveness of an occurrence or situation, and/or inhibiting the progression in severity and/or extensiveness.

As used herein, reference to a “microbe-based composition” means a composition that comprises components that were produced as the result of the growth of microorganisms or other cell cultures. Thus, the microbe-based composition may comprise the microbes themselves and/or by-products of microbial growth. Preferably, the compositions according to the subject invention comprise inactivated microbes, or have been separated from the microbes altogether. The by-products of microbial growth may be, for example, metabolites (e.g., biosurfactants), cell membrane components, expressed proteins, and/or other cellular components.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, an “isolated” or “purified” nucleic acid molecule, polynucleotide, polypeptide, protein or organic compound, such as a small molecule, is substantially free of other compounds, such as cellular material, with which it is associated in nature. In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” means a negative alteration of at least 1%, 5%, 10%, 25%, 50%, 75%, or 100%.

As used herein, “reference” means a standard or control condition.

A “metabolite” refers to any substance produced by metabolism (e.g., a growth by-product) or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, biosurfactants, enzymes, acids, solvents, gasses, alcohols, proteins, vitamins, minerals, microelements, amino acids, and polymers.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or derived from naturally-occurring substrates.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Microemulsion Compositions for Enhanced Acidizing Treatments

In preferred embodiments, the subject invention provides an improved acidizing composition, wherein the composition comprises a biosurfactant-based additive. In some embodiments, the biosurfactant is used to produce a stable microemulsion with one or more other acidizing additives, wherein the microemulsion can be pre-mixed and stored and/or transported for an extended of time prior to delivery to an oilfield for application.

Biosurfactants are a structurally diverse group of surface-active substances produced by microorganisms. Biosurfactants are biodegradable and can be produced using selected organisms in or on renewable substrates.

All biosurfactants are amphiphiles. They consist of two parts: a polar (hydrophilic) moiety and non-polar (hydrophobic) group. Due to their amphiphilic structure, biosurfactants increase the surface area of hydrophobic water-insoluble substances, increase the water bioavailability of such substances, and change the properties of bacterial cell surfaces. Additionally, biosurfactants accumulate at interfaces, and reduce the surface and interfacial tension between the molecules of liquids, solids, and gases, thus leading to the formation of aggregated micellar structures in solution.

Furthermore, biosurfactants can modify the properties of the oil and the interactions between oil, water, and the porous media in which oil and gas originate, thereby increasing the mobility, and consequently the recovery, of oil. Thus, the compositions and methods of the subject invention can increase recovery of crude oil and natural gas from oil and gas containing formations by dramatically reducing both the surface and interfacial tension between substances within the formations and by altering the wettability of formations.

Biosurfactants useful according to the subject invention include, for example, glycolipids, lipopeptides, fatty acid esters, fatty acid ethers, flavolipids, phospholipids, lipoproteins, lipopolysaccharide-protein complexes, and/or polysaccharide-protein-fatty acid complexes.

In one embodiment, the biosurfactants are glycolipids, for example, rhamnolipids (RLP), rhamnose-d-phospholipids, trehalose lipids, trehalose dimycolates, trehalose monomycolates, mannosylerythritol lipids (MEL), cellobiose lipids, ustilagic acids and/or sophorolipids (SLP) (including lactonic forms and/or linear forms); and/or lipopeptides, such as, for example, surfactin, iturin, fengycin, arthrofactin, viscosin, amphisin, syringomycin, and/or lichenysin.

In certain embodiments, the biosurfactant is a sophorolipid (SLP). Sophorolipids are glycolipid biosurfactants produced by, for example, various yeasts of the Starmerella clade when cultivated in the presence of a hydrocarbon-based source of one or more fatty acids. SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-49-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and are obtained as a collection of 30 or more types of structural homologues:

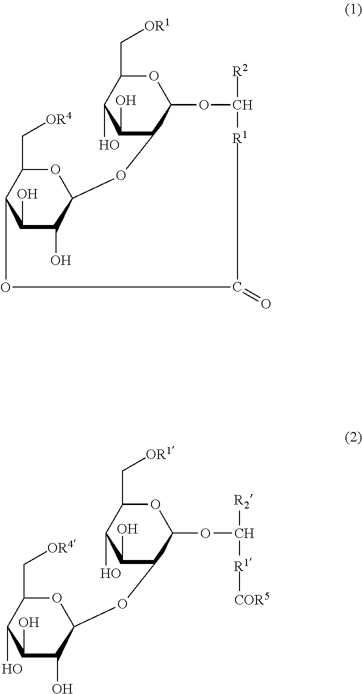

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃. R⁵ is typically, but not limited to, —OH.

The composition utilized according to the subject methods can comprises more than one form of SLP, including linear SLP and lactonic SLP. The SLP can be non-acetylated, mono-acetylated and/or di-acetylated SLP. The SLP can also be derivatized with the addition of one or more, e.g., sulfonate groups, amino acid groups, ester groups, or other groups.

In certain embodiments, the composition comprises a mixture of lactonic and linear SLP comprising, with respect to total SLP: 0.01 to 99.99%, 0.1 to 99.9%, 1 to 99%, 5 to 95%, 10 to 90%, 20 to 80%, 30 to 70%, 40 to 60% or 50% lactonic SLP and 99.99 to 0.01%, 99.9 to 0.1%, 99 to 1%, 95 to 5%, 90 to 10%, 80 to 20%, 70 to 30%, 60 to 40% or 50% linear SLP. The ratio of lactonic to linear SLP can be, for example, 10/90, 20/80, 30/70, 40/60, 50/50, 60/40, 70/30, 80/20, 90/10, and any ratio therebetween.

In certain embodiments, the biosurfactant is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

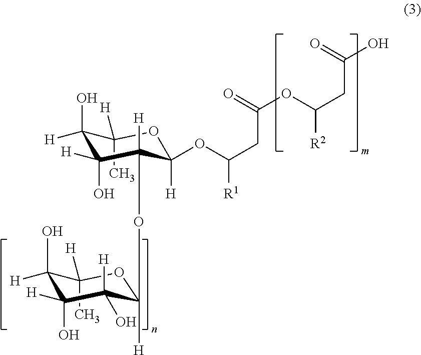

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids.

In certain embodiments, the composition comprises a mixture of SLP with RLP, comprising, with respect to total biosurfactant: 0.01 to 99.99%, 0.1 to 99.9%, 1 to 99%, 5 to 95%, 10 to 90%, 20 to 80%, 30 to 70%, 40 to 60% or 50% SLP and 99.99 to 0.01%, 99.9 to 0.1%, 99 to 1%, 95 to 5%, 90 to 10%, 80 to 20%, 70 to 30%, 60 to 40% or 50% RLP. The ratio of RLP to SLP can be, for example, 10/90, 20/80, 30/70, 40/60, 50/50, 60/40, 70/30, 80/20, 90/10, and any ratio therebetween.

In certain embodiments, the composition comprises components that were produced as the result of the growth of microorganisms or other cell cultures. Thus, the composition may comprise the microbes themselves and/or by-products of microbial growth. In some embodiments, the biosurfactants are purified from the cell culture. In some embodiments, they are utilized in crude form, wherein the crude form comprises residual cells, fermentation broth, growth by-products, and/or nutrients from fermentation. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed, active or inactive. In some embodiments, the microbes are present, with medium in which they were grown, in the composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹², or 1×10¹³ (or any concentration there-between) or more CFU per milliliter or per gram of the composition. If present, the microbe cells are preferably inactivated prior to use by, for example, heat inactivation.

In certain embodiments, use of fermentation products according to the subject invention can be superior to, for example, purified microbial metabolites alone, due to, for example, the advantageous properties of the microbial cell walls. These properties include high concentrations of mannoprotein as a part of yeast cell wall's outer surface (mannoprotein is a highly effective bioemulsifier) and the presence of biopolymer beta-glucan (also an effective emulsifier) in yeast cell walls. Additionally, the fermentation product can further comprise the biosurfactants capable of reducing both surface and interfacial tension, enzymes and other metabolites (e.g., lactic acid, ethyl acetate, ethanol, etc.) that are capable of, for example, enhancing oil recovery.

In certain embodiments the concentration of the biosurfactant(s), either individually or combined, is at or above about 0.001 ppm to about 20,000 ppm, about 5 ppm to about 15,000 ppm, about 10 ppm to about 10,000 ppm, about 100 ppm to about 600 ppm, or about 1 to 20 ppm, relative to the total fluid being applied and/or treated.

In certain embodiments, the amount of the biosurfactant(s), either individually or combined, is about 0.01% to 75%, about 0.1% to 50%, about 0.5% to about 45%, about 0.75% to about 40%, about 1% to about 35%, about 1.25% to about 30%, or about 1.5% to about 25% % with respect to the total composition (v/v or wt %).

In addition to a biosurfactant or a blend of biosurfactants, the composition can comprise one or more other acidizing additives. Some or all of the additives can be blended with the biosurfactant in the form of a microemulsion. In some embodiments, however, some or all of the additives can be administered separately and/or mixed immediately (e.g., within 24 hours) prior to administration down an oil well.

In certain embodiments, the composition comprises one or more acids such as organic acids selected from, for example, acetic acid, citric acid, formic acid, lactic acid, malic acid, oxalic acid, tartaric acid, uric acid, propionic acid, butyric acid, sorbic acid, fumaric acid, benzoic acid, hydrofluoric acid, caproic acid, salicylic acid, gluconic acid, pyruvic acid, adipic acid, trichloroacetic acid, glycolic acid, cinnamic acid, carboxylic acids, succinic acid, carbonic acid, glutaric acid, decanoic acid, and ascorbic acid; and/or inorganic acid selected from, for example, hydrochloric acid, sulfuric acid, nitric acid, phosphoric acid, boric acid, perchloric acid, hydrofluoric acid, hydrobromic acid, and sulfonic acid.

In some embodiments, the type and/or combination of acid types is dependent upon the geologic composition of the subterranean formation. For example, in some embodiments, HCl may be used when the formation comprises carbonate reservoirs, or limestones and dolomites. HF may be useful for dissolving quartz, sand and clary from reservoir rocks. In some embodiments, a combination of acids is used because, for example, the formation is heterogeneous in its geologic composition.

The one or more acids are preferably used, either individually or combined, at about 0.01% to 50%, about 0.5% to about 45%, about 0.75% to about 40%, about 1% to about 35%, about 1.25% to about 30%, or about 1.5% to about 25% with respect to the total composition (v/v or wt %).

In certain embodiments, the use of a biosurfactant in the composition can reduce and/or replace traditional solvents and/or surfactants used in acidizing formulations; however, in some embodiments, the compositions can still comprise these components.

In certain embodiments, the composition comprises one or more polar or non-polar fluids, including solvents selected from, for example, glycol ethers, terpenes and/or terpenoids (e.g., limonenes, orange terpenes, lemon terpenes, grapefruit terpenes, orange oil, lemon oil, other citrus terpenes, other citrus oils, geraniol, terpineol, dipentene, myrcene, linalool, cymene and pinene), alcohols (e.g., ethanol, methanol, propanol, isopropyl alcohol and/or hexanol), ionic or semi-ionic liquids, acetates (e.g., isoamyl acetate and/or primary amyl acetate), aliphatic and/or aromatic hydrocarbons, olefins, esters, oxygenates, ketones, acetic acid, kerosene, gasoline, diesel, benzene, ethyl benzenes, propyl benzenes, butyl benzenes, hexane, toluene, ethyl toluenes, xylene, alkylene amines, carbon disulfide, mesitylene, cumene, pseudocumene, cymenes, saturated aliphatic and/or alicyclic hydrocarbons, naphtha, naphthenes, decalin, tetralin, turpentine, carbon tetrachloride, ether alcohol, pinene, dialkyl ether, water, brine, produced water, and/or any combination thereof.

In certain embodiments, the composition comprises both a polar fluid and a non-polar fluid. The one or more solvents are preferably present, either individually or combined, at about 0.01% to 50%, about 0.5% to about 45%, about 0.75% to about 40%, about 1% to about 35%, about 1.25% to about 30%, or about 1.5% to about 25% with respect to the total composition (v/v or wt %).

Additionally in certain embodiments, the composition can comprise one or more secondary surfactants. The secondary surfactant(s) can be of non-biological origin and/or they can be biosurfactants, meaning surfactants produced by a living cell and/or using naturally-derived substrates. Surfactants can be, for example, anionic, cationic, zwitterionic and/or nonionic.

Surfactants are surface active agents having two functional groups, namely a hydrophilic (water-soluble) or polar group and a hydrophobic (oil-soluble) or non-polar group. The hydrophobic group is usually a long hydrocarbon chain (C8-C18), which may or may not be branched, while the hydrophilic group is formed by moieties such as carboxylates, sulfates, sulfonates (anionic), alcohols, polyoxyethylenated chains (nonionic) and quaternary ammonium salts (cationic).

Surfactants according to the subject compositions and methods include, but are not limited to: alkyl polyglycosides, methyl glucoside esters, polyglycol esters, alcohol ethoxylates, alkali metal alkyl sulfates, alkyl alkylaryl sulfonates, linear or branched alkyl ether sulfates, sulfonates, alcohol polypropoxylated sulfates, alcohol polyethoxylated sulfates, alkyl or alkylaryl disulfonates, alkyl disulfates, alkyl sulphosuccinate, alkyl ether sulfates, linear and branched ether sulfates, arginine methyl esters, alkanolamines, alkylenedilamides, propoxylated surfactants, ethoxylated surfactants, ethoxylated nonyl phenol phosphate esters, alkyl glucoside, alkyl phosphonium chloride, alkyl phosphonate surfactants, linear alcohols, nonylphenol compounds, quaternary amines, alkyoxylated fatty acids, alkylphenol alkoxylates, ethoxylated amides, methyl ester sulfonates, hydrolyzed keratin, sulfosuccinates, taurates, disodium oxybis(decylbenzenesulphonate), isopropanolamine dodecylbenzene sulfonate (or acid form DDBSA), disodium decyl(sulfonatophenoxy)benzenesulfonate, polyethylene glycol undecyl ether, propylene glycol, trimethyltallowammonium chloride, trimethylcocoammonium chloride, quaternary alkyl ammonium chloride, propargyl alcohol, acetylenic alcohol, phosphate esters, imidazolines, amine salts, amide salts, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, sulfonated olefins, anionic surfactants, ammonium lauryl sulfate, sodium lauryl sulfate (also called SDS, sodium dodecyl sulfate), alkyl-ether sulfates sodium laureth sulfate (also known as sodium lauryl ether sulfate (SLES)), sodium myreth sulfate; docusates, dioctyl sodium sulfosuccinate, perfluorooctanesulfonate (PFOS), perfluorobutanesulfonate, linear alkylbenzene sulfonates (LABs), alkyl-aryl ether phosphates, alkyl ether phosphate; carboxylates, alkyl carboxylates (soaps), sodium stearate, sodium lauroyl sarcosinate, carboxylate-based fluorosurfactants, perfluorononanoate, perfluorooctanoate; cationic surfactants, pH-dependent primary, secondary, or tertiary amines, octenidine dihydrochloride, permanently charged quaternary ammonium cations, alkyltrimethylammonium salts, cetyl trimethylammonium bromide (CTAB) (a.k.a. hexadecyl trimethyl ammonium bromide), cetyl trimethylammonium chloride (CTAC), cetylpyridinium chloride (CPC), benzalkonium chloride (BAC), benzethonium chloride (BZT), 5-Bromo-5-nitro-1,3-dioxane, dimethyldioctadecylammonium chloride, cetrimonium bromide, dioctadecyldi-methylammonium bromide (DODAB); zwitterionic (amphoteric) surfactants, sultaines CHAPS (3-[(3-Cholamidopropyl)dimethylammonio]-1-propanesulfonate), cocamidopropyl hydroxysultaine, betaines, cocamidopropyl betaine, phosphatidylserine, phosphatidylethanolamine, phosphatidylcholine, sphingomyelins; nonionic surfactants, ethoxylate, long chain alcohols, fatty alcohols, cetyl alcohol, stearyl alcohol, cetostearyl alcohol, oleyl alcohol, polyoxyethylene glycol alkyl ethers (Brij): CH3-(CH2)10-16-(O—C2H4)1-25-OH (octaethylene glycol monododecyl ether, pentaethylene glycol monododecyl ether), polyoxypropylene glycol alkyl ethers: CH3-(CH2)10-16-(O—C3H6)1-25-OH, glucoside alkyl ethers: CH3-(CH2)10-16-(O-Glucoside)1-3-OH (decyl glucoside, lauryl glucoside, octyl glucoside), polyoxyethylene glycol octylphenol ethers: C8H17-(C6H4)-(O—C2H4)1-25-OH (Triton X-100), polyoxyethylene glycol alkylphenol ethers: C9H19-(C6H4)-(O—C2H4)1-25-OH (nonoxynol-9), glycerol alkyl esters (glyceryl laurate), polyoxyethylene glycol sorbitan alkyl esters (polysorbate), sorbitan esters, sorbitan alkyl esters (spans), cocamide MEA, cocamide DEA, dodecyldimethylamine oxide, copolymers of polyethylene glycol and polypropylene glycol (poloxamers), and polyethoxylated tallow amine (POEA).

Anionic surfactants contain anionic functional groups at their head, such as sulfate, sulfonate, phosphate, and carboxylates. Prominent alkyl sulfates include ammonium lauryl sulfate, sodium lauryl sulfate (also called SDS, sodium dodecyl sulfate) and the related alkyl-ether sulfates sodium laureth sulfate, also known as sodium lauryl ether sulfate (SLES), and sodium myreth sulfate. Carboxylates are the most common surfactants and comprise the alkyl carboxylates (soaps), such as sodium stearate.

Surfactants with cationic head groups include: pH-dependent primary, secondary, or tertiary amines; octenidine dihydrochloride; permanently charged quaternary ammonium cations such as alkyltrimethylammonium salts: cetyl trimethylammonium bromide (CTAB) a.k.a. hexadecyl trimethyl ammonium bromide, cetyl trimethylammonium chloride (CTAC); cetylpyridinium chloride (CPC); benzalkonium chloride (BAC); benzethonium chloride (BZT); 5-Bromo-5-nitro-1,3-dioxane; dimethyldioctadecylammonium chloride; cetrimonium bromide; and dioctadecyldi-methylammonium bromide (DODAB).

Zwitterionic (amphoteric) surfactants have both cationic and anionic centers attached to the same molecule. The cationic part is based on primary, secondary, or tertiary amines or quaternary ammonium cations. The anionic part can be more variable and include sulfonates. Zwitterionic surfactants commonly have a phosphate anion with an amine or ammonium, such as is found in the phospholipids phosphatidylserine, phosphatidylethanolamine, phosphatidylcholine, and sphingomyelins.

A surfactant with a non-charged hydrophilic part, e.g., ethoxylate, is non-ionic. Many long chain alcohols also exhibit some surfactant properties.

In an exemplary embodiment, the secondary surfactants comprise an ethoxylated C12-C16 alcohol, alkyl polyglucosides, benzenesulfonic acid, isopropanolamine, sulfonates, cocodiethanol amine, DDBSA and/or commercial surfactant blends. The one or more surfactants are preferably present, either individually or combined, at about 0.01 to 65%, about 0.25 to 60%, about 0.5 to 55%, about 0.75 to 50%, or about 1 to 45% with respect to the total composition (v/v or wt %).

In one embodiment, the composition further comprises one or more corrosion inhibitors such as, for example, acetylenic alcohols, such as propargyl alcohol organic amines, dimer/trimer acids derived from tall oil or other bases, quaternary amines derived from coconut, canola, tallow, tall oil or other bases, fatty alcohols, derivatized quinolines, alkyl pyridines and oxyalkylated resin amines.

The one or more corrosion inhibitors are preferably present, either individually or combined, at about 0.01 to 25%, or about 0.25 to 20%, or about 0.5 to 15%, about 0.75 to 12%, or about 1 to 10% with respect to the total composition (v/v or wt %).

Surprisingly, though iron chelators are typically required additives in any acidizing treatment, embodiments of the the subject composition can perform the function of iron chelator without addition of a standard iron chelator. Nonetheless, in one embodiment, the composition further comprises one or more chelating agents such as, for example, EDTA (ethylenediamine tetraacetic acid), HEDTA (hydroxyethylenediamine triacetic acid), disodium EDTA, nitrilioacetic acid (NTA), erythorbic acid, sodium acetate, glycolic acid, thioglycolic acid, 2-mercaptoethanol, thioglycerol, hypophosphorous acid, inorganics (e.g., copper, antimony, bismuth, iodide) quaternary ammonium compounds, 2-mercaptoethanol, stannous chloride, phosphonates, succimer (DMSA), diethylenetriaminepentaacetate (DTPA), organic acids with more than one coordination group (e.g., rubeanic acid), STPP (sodiumtripolyphosphate, Na5P3O10), trisodium phosphate (TSP), water, carbohydrates, organic acids with more than one coordination group (e.g., citric acid), citrate, lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na4, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

The one or more chelating agents are preferably present, either individually or combined, at about 0.1% to 50%, about 0.5% to about 45%, about 0.75% to about 40%, about 1% to about 35%, about 1.25% to about 30%, or about 1.5% to about 25% % with respect to the total composition (v/v or wt %).

The subject composition can further comprise carriers (e.g., water, oil and/or brine fluids) as well as other additives that are useful for acidizing and fracture acidizing, including, for example, mutual solvents, co-solvents, co-surfactants, wetting agents, foaming agents, silt-suspending agents, anti-sludging agents, proppants, viscosity modifiers, emulsifiers and enzymes. Brine fluids can comprise salts such as, for example, ammonium chloride, sodium chloride, potassium chloride, and/or combinations thereof.

These additional compounds can be added at concentrations ranging from, for example, about 0.001% to 50%, about 0.01% to 25%, or about 0.1% to 10%, by weight or volume of the total composition.

In preferred embodiments, the biosurfactant according to the subject invention is utilized in formulating the composition into a stable microemulsion. Microemulsions are thermodynamically stable fluid dispersions of two or more immiscible liquids, such as oil and water, or a polar phase and a non-polar phase. Microemulsions form when a surfactant, or more commonly a mixture of surfactants and co-surfactants, lowers the oil/water interfacial tension to ultra-low values (e.g., less than 0.001 dynes/cm), allowing thermal motions to spontaneously disperse the immiscible phases. Techniques for forming microemulsions are known in the art.

Advantageously, when formulated as a microemulsion, the compositions of the subject invention are shelf stable for at least one week or longer, and can be transported, stored and then applied selectively to an oil well at any point, for example, after a decline in production is observed.

### Methods of Enhanced Acidizing

The subject invention further provides methods for enhancing oil recovery from an oil-bearing formation wherein an acidizing composition according to the subject invention is applied to an oil well associated with the formation.

In certain embodiments, the methods comprise pre-formulating the composition as a microemulsion prior to transport and/or application to a well. In other embodiments, individual ingredients can be mixed on-site and/or applied to the well as separate treatments that mix in situ within the well. In some embodiments, some of the ingredients are pre-mixed, while others are added on-site and/or injected separately to the well from the pre-mixed formulation.

In one embodiment, the subject invention provides methods for removing, inhibiting and/or preventing the deposition of contaminants and sediments such as biofilm, scale, sludge, paraffin, and/or asphaltene in oil wells and oil and gas production equipment.

In some embodiments, the methods improve the efficiency of oil and/or gas recovery by, e.g., decreasing the amount of resources and energy required to recover oil and/or gas from a formation, and in general, increasing the amount of oil and/or gas recovered over a certain period of time. Furthermore, the methods can decrease the amount of steps and energy required for acidizing treatments, thereby providing for simplified methods of increasing the porosity and permeability of a formation.

Even further, in addition to ultimately increasing the amounts of crude oil recovered from a well due to the opening and/or enlarging of formation rock pores and/or causing the formation of fractures, the methods also enhance oil recovery through, for example, the amphiphilic properties of surfactants, including biosurfactants. The use of biosurfactants in oil recovery can effectively alter the wettability of formation rock and decrease the surface/interfacial tension downhole, thereby facilitating and/or stimulating the flow of oil from the formation.

The subject invention can be utilized in matrix acidizing, fracture acidizing and acid washing. The compositions and methods can also be utilized as a pre-flush treatment to, e.g., dissolve and minimize precipitation of calcareous material; to dissolve iron scale and avoid the precipitation of ferric hydroxide; to displace reservoir brine from the near wellbore area to avoid adverse interactions with chemical flooding solutions; to adjust reservoir salinity to favorable conditions; to prevent the production of high viscosity stable combinations with in situ fluids, such as sludges, emulsions and organic precipitations; and/or to remove deposits, such as paraffin, asphaltene and scale, from oil- and/or natural gas-bearing formations, and/or the wells and production equipment associated therewith.

In certain embodiments the methods can be used to increase the porosity and/or the permeability of an oil-bearing formation by, for example, about 0.1% to about 20% or more.

The subject invention can be used in, for example, vertical, horizontal and/or fracking wells, mature wells, depleted (marginal) wells, flowlines, to clean near wellbore zones and to clean storage tanks. Advantageously, use of the subject invention can improve and/or enhance oil recovery, aid in well stimulation, and restore the health (e.g., production capacity) of under-producing or even dead wells.

As used herein, “applying” a composition or product refers to contacting it with a target or site such that the composition or product can have an effect on that target or site. The effect can be due to, for example, the individual ingredients of the subject compositions and/or a synergistic combination thereof. There are multiple ways that the method may be implemented using a composition according to the subject invention, for example, the compositions and/or individual ingredients thereof can be injected into oil wells and/or the piping, tubulars, casing, annulus, pumps, and tanks associated with oil-bearing formations, oil wells, oil production, oil transmission and oil transportation.

Application of the composition can be performed during drilling operations (e.g., while drilling, while tripping-in or tripping-out of the hole, while circulating mud, while casing, while placing a production liner, and/or while cementing, etc.). Application can also occur as a production treatment, for example, by introducing the composition into an oil well after oil production is underway and/or after a decline in the rate of oil production from the formation has occurred.

The volume of treatment used can be determined taking into account, for example, formation porosity, permeability and deposit thickness. In some embodiments, the treatment can produce effects in less than 24 hours of shut-in time.

Formation permeability determines the pumping pressure required to place the acid into the formation. In general, the lower the permeability, the higher the pumping pressure. In high permeability formations the acid can be pumped into the matrix of the formation at relatively low pumping pressures. In lower permeability formations the acid cannot be pumped into the formation matrix as readily, but is pumped through existing or induced fractures at higher pumping pressures.

In one embodiment, the present invention provides a method of enhanced acidizing and/or a method of pre-flushing a subterranean formation comprising introducing an aqueous treatment fluid that comprises a biosurfactant, an acid, and optionally, one or more acidizing additives into at least a portion of the subterranean formation. The treatment can restore the permeability of the formation by, e.g., dissolving scale, sediments and mud solids that plug the rock pores, thus enlarging the pores and stimulating the flow of hydrocarbons. The acid can also dissolve formation rock itself to increase permeability.

In one embodiment, the present invention provides a method of enhanced acid fracking comprising introducing an aqueous treatment fluid that comprises a biosurfactant, an acid, and optionally, one or more acidizing additives into at least a portion of a subterranean formation, and performing a fracturing treatment in the subterranean formation.

In one embodiment, the present invention provides a method of enhancing acid washing comprising introducing a biosurfactant, an acid, and optionally, one or more acidizing additives into tubulars and wellbore of an oil well to dissolve scale and other sediments therein. This can be useful for fixing and/or preventing damage to perforations, tubing, and the near-wellbore zone caused by fine particles, mud or cement filtrate, scale and debris from well operations.

The methods may further include performing an operation after the introduction of the biosurfactant-based acidizing composition. The operation may be or include, but is not limited to, water-based flooding, gas injection recovery method and thermal methods. Non-limiting examples of water-based flooding/chemical flooding may be or include polymer flooding, ASP flooding, SP flooding, microbial flooding, low-salinity flooding and the like. Gas injection methods may be or include miscible flooding and immiscible flooding, such as carbon dioxide flooding. Thermal methods may include hot water or steam injection or in situ combustion. The operation may have an improved efficiency and/or increased hydrocarbon recovery as compared to an otherwise identical operation absent the pre-flush composition because there is a reduced amount of non-mobile non-polar material impeding the reservoir path.

The volume of acid used in an acid job is generally determined by the length of the formation (footage) being treated in the well. Acid volumes used per foot of formation can vary depending on the design objectives and the characteristics of the specific formation. Typical acid volume ranges are between 10 and 500 gallons per foot. In fracture acid jobs, the acid will be displaced further, but is still limited by the fracture length. Fracture lengths can range from, for example, 100 to 1000 feet.

To facilitate placement of the acid across the entire target interval in the well, the method may comprise applying the composition using coiled tubing units. A coiled tubing unit is a specialized piece of equipment that utilizes a reel mounted tubing string that can be run concentrically inside the well's production tubing to the point directly across the interval that is targeted for treatment. The composition is pumped through the coiled tubing and into the productive formation. This equipment allows precise placement and pumping of the acid. It also provides the added benefit of not exposing the production tubing to the acid.

When pumping any fluid into a well it will have a natural tendency to follow the path of least resistance and flow into those parts of the formation with the highest permeability. In certain embodiments, the methods comprise employing a diverter to force the composition into lower permeability sections relative to other permeability sections of the formation. The diverters can be either chemical or physical flow diverters.

In certain embodiments, the methods comprise shutting in a well after treatment with the subject compositions. The well can be shut in for 12 hours to 24 hours to 7 days or more.

In one exemplary embodiment, the methods comprise pumping, for example, 100 to 1,000 gallons of more of the composition into an oil well. Injection rates can be determined by a skilled oil well operation, although, as an example, an injection rate of 1 to 20 gallons per minute, or 1 to 20 barrels per minute can be used in some embodiments.

In some embodiments, the composition can be introduced into the formation through perforations in the casing. The composition may be forced into the surrounding formation by applied pressure or, if the composition is allowed to set at the bottom of the casing, the composition may seep into the formation without additional pressure.

Once an acidizing job has been pumped the well is, in some embodiments, brought on production. When this is done, the spent acid is produced along with the oil, gas, and water in the formation. The acid is chemically consumed and neutralized as the target material is dissolved. In carbonate formations, for example, the acid reacts with the carbonate to form a salt, carbon dioxide, and water.

The subject methods can be effective in a range of different geologic formations. For example, the subject invention can be useful in formations as deep as about 7,000 feet or deeper, and as shallow as about 1,500 feet or shallower.

The invention can also be useful in formations having a wide range of temperatures, pH, and salinity. For example, the subject invention can be utilized in recovery and transport of oil in locations where lower temperatures might cause paraffin deposition, such as, for example, in offshore wells, in the arctic or Antarctic, and in climates that experience cold winter temperatures.

Additionally, the subject invention can be utilized in oil wells with high formation water salinity levels. For example, the compositions can be useful in geologic regions where formation water salinity is up to 250,000 ppm (total dissolved solids), up to 300,000 ppm, or even up to 400,000 ppm or more.

In one embodiment, the subject compositions and methods can be used without releasing large quantities of inorganic compounds into the environment. Additionally, the compositions and methods can utilize components, such as biosurfactants, that are biodegradable and toxicologically safe. Thus, while the subject invention can utilize non-biological or synthetic chemical components, the present invention can also be formulated as an environmentally-friendly treatment.

### Additional Considerations

In certain embodiments, the method comprises applying the composition with one or more further additives. Up to, for example, 50 wt. % or more of further additives may be applied, as needed, for particular applications, such as to vary the VOC levels, increase penetration of the mixture, decrease viscosity of the mixture, and/or as couplers for solvent insolubles in the mixture.

Suitable additives include, but are not limited to, alcohol ethoxylates, ethoxysulfates, C8-C14 alcohol ester blends, glycols, glycol ethers, acid esters, diacid esters, petroleum hydrocarbons, amino acids, alkanolamines, amines, methyl or isobutyl esters of C4-C6 aliphatic dibasic esters and n-methyl-2 pyrolidone.

C8-C14 alcohol ester blends include EXXATE 900, 1000, 1200 from Exxon Chemical; glycols include propylene glycol, dipropylene glycol, and triproplylene glycol; and glycol ethers include dipropylene glycol monomethyl ether, propylene glycol monomethyl ether, propylene glycol-n-butyl ether, ethylene glycol monobutyl ether, and diethylene glycol monobutyl ether. Acid esters include methyl oleate and methyl linoleate, and diacid esters include methyl or butyl diesters of glutaric, adipic, and succinic acids. Petroleum hydrocarbons include AROMATIC 100, AROMATIC 150 ISOPAR M, and ISOPAR K.

Amines such as morpholine; 1,3-dimethyl-2-imidazolidinone; 1, 3-propanediamine; 2-amino-1,3-propanediol; and 3-amino propanol; as well as alkanolamines such as triethanolamine, diethanolamine, 2-aminomethyl propanol, and monoethanolamine act as dispersants for contaminants and solubilize fatty acids and oils. Amino acids, provide nontoxic alternatives to monoethanolamine, and act as metal chelators. Methyl or isobutylesters of C4-C6 aliphatic dibasic esters and n-methyl-2 pyrolidone are also useful.

All additives should have a flash point greater than 100° F., preferably greater than 150° F. and more preferably 195° F. TCC in order to achieve a final product flash point greater than 200° F.

In some embodiments, the composition can be used alongside and/or formulated with known scale inhibitors, for example, phosphonates, phosphate esters and/or polyacrylates.

Other suitable additives include, for example, emulsifying agents, demulsifiers, lubricants, buffering agents, solubility controlling agents, pH adjusting agents, preservatives and, stabilizers.

### Production of Microbe-Based Products

In one embodiment, the subject invention provides methods of producing a microbial metabolite by cultivating a microbe under conditions appropriate for growth and production of the metabolite; and, optionally, purifying the metabolite. In a specific embodiment, the metabolite is a biosurfactant. The metabolite may also be, for example, ethanol, lactic acid, beta-glucan, proteins, amino acids, peptides, metabolic intermediates, polyunsaturated fatty acids, and lipids. The metabolite content produced by the method can be, for example, at least 20%, 30%, 40%, 50%, 60%, 70%, 80%, or 90%.

The microorganisms utilized according to the subject invention may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium, NRRL B-67928, NRRL B-68031, ATCC PTA-123459); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus, NRRL Y-68030); Williopsis spp.; and/or Zygosaccharomyces spp. (e.g., Z. bailii).

In certain embodiments, the microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214. These yeasts are known sophorolipid producers.

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, samples may be taken from the vessel for enumeration, purity measurements, biosurfactant concentration, and/or visible oil level monitoring. For example, in one embodiment, sampling can occur every 24 hours.

The microbial inoculant according to the subject methods preferably comprises cells and/or propagules of the desired microorganism, which can be prepared using any known fermentation method. The inoculant can be pre-mixed with water and/or a liquid growth medium, if desired.

In certain embodiments, the cultivation method utilizes submerged fermentation in a liquid growth medium. In one embodiment, the liquid growth medium comprises a carbon source. The carbon source can be a carbohydrate, such as glucose, dextrose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as canola oil, soybean oil, rice bran oil, olive oil, corn oil, sunflower oil, sesame oil, and/or linseed oil; powdered molasses, etc. These carbon sources may be used independently or in a combination of two or more. In preferred embodiments, a hydrophilic carbon source, e.g., glucose, and a hydrophobic carbon source, e.g., oil or fatty acids, are used.

In some embodiments, the cultivation method utilizes reduced amounts of a carbon source, compared with standard methods in the art. For example, in some embodiments, the liquid growth medium can comprise a sugar (e.g., glucose) and an oil (e.g., canola oil) at amounts of 25-70 g/L and 25-70 ml/L, respectively. Advantageously, in some embodiments, reducing the amount of sugar and oil in the liquid growth medium reduces the amount of glucose and/or oil impurities left in the culture, thus enhancing the ability to purify the SLP molecules to greater degrees of purity.

In one embodiment, the liquid growth medium comprises a nitrogen source. The nitrogen source can be, for example, yeast extract, potassium nitrate, ammonium nitrate, ammonium sulfate, ammonium phosphate, ammonia, urea, and/or ammonium chloride. These nitrogen sources may be used independently or in a combination of two or more.

In one embodiment, one or more inorganic salts may also be included in the liquid growth medium. Inorganic salts can include, for example, potassium dihydrogen phosphate, monopotassium phosphate, dipotassium hydrogen phosphate, disodium hydrogen phosphate, potassium chloride, magnesium sulfate, magnesium chloride, iron sulfate, iron chloride, manganese sulfate, manganese chloride, zinc sulfate, lead chloride, copper sulfate, calcium chloride, calcium carbonate, calcium nitrate, magnesium sulfate, sodium phosphate, sodium chloride, and/or sodium carbonate. These inorganic salts may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, proteins and microelements can be included, for example, corn flour, peptone, yeast extract, potato extract, beef extract, soybean extract, banana peel extract, and the like, or in purified forms. Amino acids such as, for example, those useful for biosynthesis of proteins, can also be included.

The method of cultivation can further provide oxygenation to the growing culture. One embodiment utilizes slow motion of air to remove low-oxygen containing air and introduce oxygenated air. The oxygenated air may be ambient air supplemented daily through mechanisms including impellers for mechanical agitation of the liquid, and air spargers for supplying bubbles of gas to the liquid for dissolution of oxygen into the liquid. In certain embodiments, dissolved oxygen (DO) levels are maintained at about 25% to about 75%, about 30% to about 70%, about 35% to about 65%, about 40% to about 60%, or about 50% of air saturation.

In some embodiments, the method for cultivation may further comprise adding additional acids and/or antimicrobials in the liquid medium before and/or during the cultivation process. Antimicrobial agents or antibiotics (e.g., streptomycin, oxytetracycline) are used for protecting the culture against contamination. In some embodiments, however, the metabolites produced by the yeast culture provide sufficient antimicrobial effects to prevent contamination of the culture.

In one embodiment, prior to inoculation, the components of the liquid culture medium can optionally be sterilized. In one embodiment, sterilization of the liquid growth medium can be achieved by placing the components of the liquid culture medium in water at a temperature of about 85-100° C. In one embodiment, sterilization can be achieved by dissolving the components in 1 to 3% hydrogen peroxide in a ratio of 1:3 (w/v).

In one embodiment, the equipment used for cultivation is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Gaskets, openings, tubing and other equipment parts can be sprayed with, for example, isopropyl alcohol. Air can be sterilized by methods know in the art. For example, the ambient air can pass through at least one filter before being introduced into the vessel. In other embodiments, the medium may be pasteurized or, optionally, no heat at all added, where the use of pH and/or low water activity may be exploited to control unwanted microbial growth.

The pH of the culture should be suitable for the microorganism of interest. In some embodiments, the pH is about 2.0 to about 7.0, about 3.0 to about 5.5, about 3.25 to about 4.0, or about 3.5. Buffers, and pH regulators, such as carbonates and phosphates, may be used to stabilize pH near a preferred value. In certain embodiments, a base solution is used to adjust the pH of the culture to a favorable level, for example, a 15% to 30%, or a 20% to 25% NaOH solution. The base solution can be included in the growth medium and/or it can be fed into the fermentation reactor during cultivation to adjust the pH as needed.

In one embodiment, the method of cultivation is carried out at about 5° to about 100° C., about 15° to about 60° C., about 20° to about 45° C., about 22° to about 35° C., or about 24° to about 28° C. In one embodiment, the cultivation may be carried out continuously at a constant temperature. In another embodiment, the cultivation may be subject to changing temperatures.

According to the subject methods, the microorganisms can be incubated in the fermentation system for a time period sufficient to achieve a desired effect, e.g., production of a desired amount of cell biomass or a desired amount of one or more microbial growth by-products. The microbial growth by-product(s) produced by microorganisms may be retained in the microorganisms and/or secreted into the growth medium. The biomass content may be, for example from 5 g/l to 180 g/l or more, or from 10 g/l to 150 g/l.

In certain embodiments, fermentation of the microbial culture occurs for about 100 to 150 hours, or about 115 to about 125 hours, or about 120 hours. The biosurfactants resulting from cultivation can be extracted and, optionally purified. Alternatively, the broth containing the biosurfactant and residual products of fermentation, including live, inactive and/or lysed microorganisms can be present.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Testing of Biosurfactant-Based Acid Additive

A biosurfactant-based acid additive was developed to replace both surfactants and solvents typically used in acidizing. Test formulations in the lab were evaluated for surfactant properties by surface tension reduction, interfacial tension reduction, wettability alteration, and ability to break emulsions. Detergency was evaluated by assessing oil removal from carbonate chips. Compatibility was assessed by emulsion testing in acid and high-temperature stability studies in an oven.

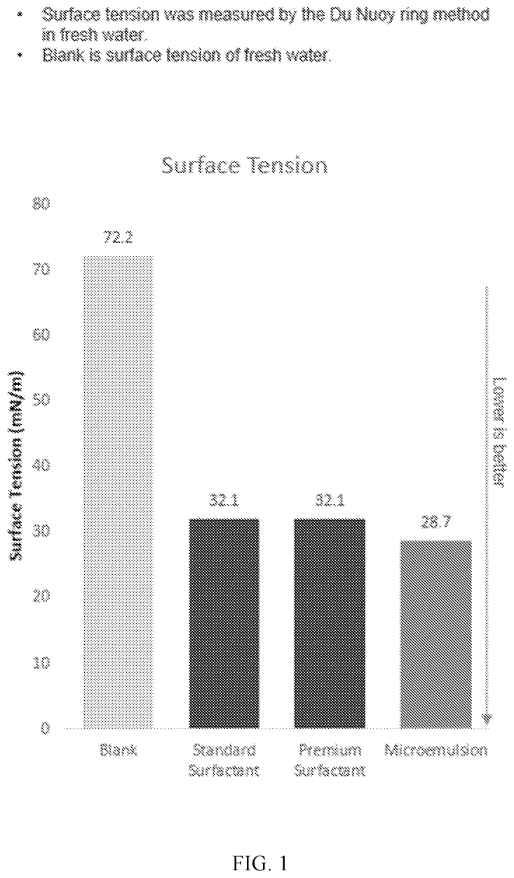

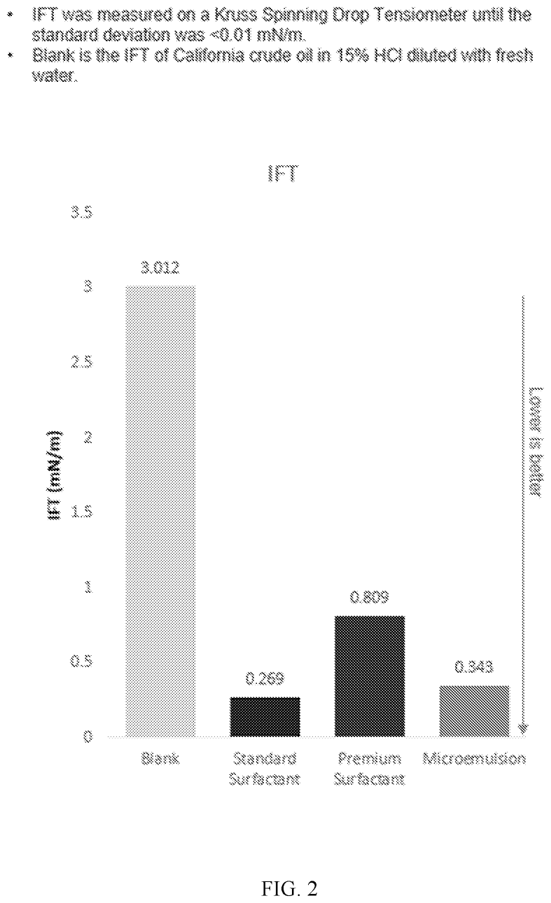

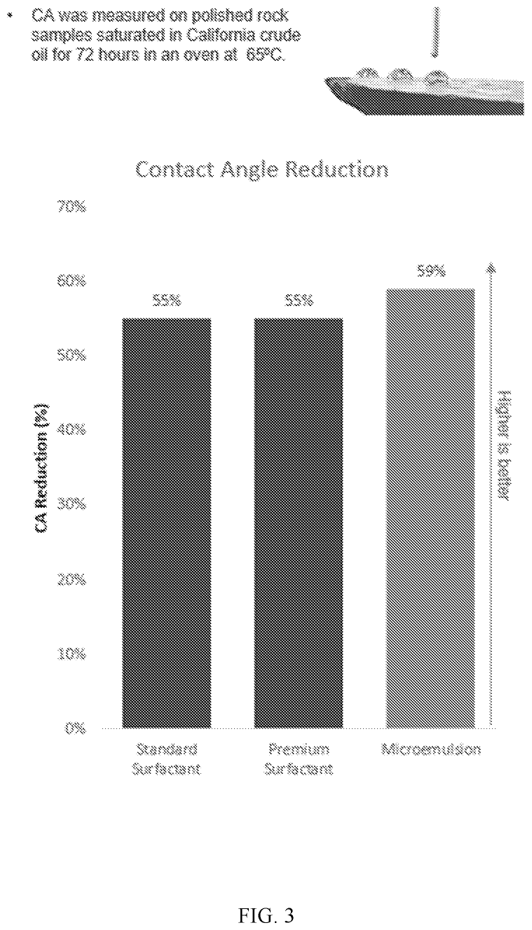

The biosurfactant-based additive is compared to a variety of industry surfactants. At equal activity, the new additive results in equivalent or better surface tension, interfacial tension, contact angle, and emulsion break in fresh water and several North American crude oils. FIGS. 1-3.

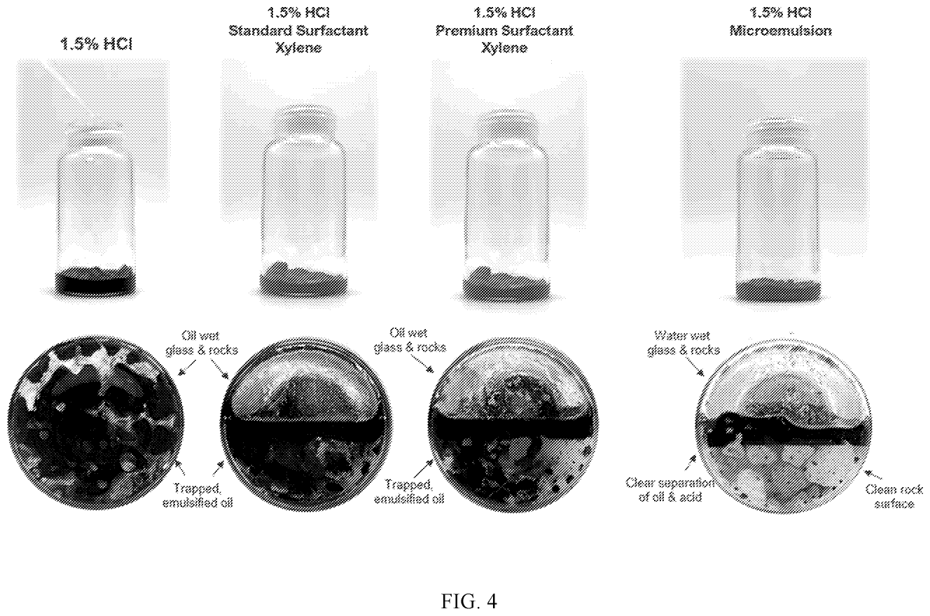

Detergency tests comparing the new additive in diluted 15% hydrochloric acid to combinations of solvent with acid and solvent with surfactant and acid in various crude oils show that the biosurfactant-based additive is significantly more effective at removing crude oil from the carbonate surface and breaking emulsions between the crude oil and acid solution. FIG. 4. The lab results show that the new additive can replace both surfactants and solvents in acidizing. In addition, because the additive is compatible with citric acid, corrosion inhibitor and hydrochloric acid, the use of the biosurfactant-based additive can also lead to simplified logistics and reduced job complexity.

### Example 2—Exemplary Formula for Biosurfactant-Based Acid Additive

The following formula is formulated with acid, chelators and/or corrosion inhibitors for effective acidizing of subterranean formations. Individual components may be pre-mixed, mixed on site, and/or applied separately for in situ mixing.

| Component | % wt |
|---|---|
| Water/brine | 5.0-10.0% |
| 2-butoxyethanol (a.k.a. butyl cellusolve; butyl | 5.0-10.0% |
| glycol) | |
| Surfactant blend comprising 1.0% or greater | 15.0-20.0% |
| but less than 30% of each of the following | |
| components (with respect to the total blend | |
| weight or volume): disodium | |
| oxybis(decylbenzenesulphonate), isopropanolamine | |
| dodecylbenzene sulfonate, disodium | |
| decyl(sulfonatophenoxy)benzenesulfonate, | |
| polyethylene glycol undecyl ether, and | |
| propylene glycol | |
| C12-C16 ethoxylated alcohols | 25.0-30.0% |
| Sophorolipid | 0.5-5.0% |
| Aromatic blend: naphtha, cumene, pseudocumene, | 30.0-40.0% |
| and xylenes | |

1. A composition for use in enhancing oil recovery from a well comprising a biosurfactant and an acidizing additive, wherein the biosurfactant is selected from sophorolipids, rhamnolipids, mannosylerythritol lipids and rhamnolipids.

2. (canceled)

3. The composition of claim 21, comprising a blend of sophorolipids and rhamnolipids.

4-5. (canceled)

6. The composition of claim 1, comprising an acidizing additive selected from solvents, co-solvents, surfactants, co-surfactants, chelators, and corrosion inhibitors.

7. The composition of claim 6, comprising:
a solvent or co-solvent selected from glycol ethers, terpenes, terpenoids, acetates, alcohols, kerosene, gasoline, diesel, benzene, toluene, hexane naphtha, cumene, pseudocumene, xylene, water, brine fluids, and produced water;
a surfactant or co-surfactant selected from ethoxylated C12-C16 alcohols, alkylpolyglucosides, sulfonates, disodium oxybis(decylbenzenesulphonate), isopropanolamine dodecylbenzene sulfonate, disodium decyl(sulfonatophenoxy)benzenesulfonate, polyethylene glycol undecyl ether, and propylene glycol;
a chelator selected from EDTA (ethylenediamine tetraacetic acid), HEDTA (hydroxyethylenediamine triacetic acid), nitrilioacetic acid (NTA), erythorbic acid, citric acid, citrate, sodium acetate, glycolic acid, thioglycolic acid, 2-mercaptoethanol, thioglycerol, hypophosphorous acid, inorganic quaternary ammonium compounds, 2-mercaptoethanol, and stannous chloride; and/or
a corrosion inhibitor selected from acetylenic alcohols; organic amines; dimer/trimer acids derived from tall oil; quaternary amines derived from coconut, canola, tallow, or tall oil; fatty alcohols; derivatized quinolines; alkyl pyridines; and oxyalkylated resin amines.

8-10. (canceled)

11. The composition of claim 1, comprising a fermentation broth resulting from cultivation of a biosurfactant-producing microorganism, wherein the fermentation broth comprises microbial cells, biosurfactants and other microbial growth by-products, and wherein the microorganism is not active, and wherein the biosurfactant-producing microorganism is Wickerhamomyces anomalus, Starmerella bombicola, Meyerozyma guilliermondii or Pseudomonas aeruginosa.

12-15. (canceled)

16. The composition of claim 1, comprising:
5.0-10.0 wt % water,
0.5-5.0 wt % biosurfactants,
15.0-50.0 wt % surfactants, and
5.0-50.0 wt % solvents.

17. The composition of claim 1, wherein the biosurfactant facilitates the formation of a microemulsion with the other ingredients in the composition, and wherein the microemulsion is stable for 48 hours or more.

18. (canceled)

19. A method for improving oil and/or gas production wherein at least one biosurfactant and one or more acidizing additives are applied with one or more acids to a subterranean formation, an oil and/or gas well, a wellbore and/or equipment associated therewith.

20. The method of claim 19, wherein the biosurfactant, acid, and acidizing additive are applied as one pre-mixed formulation.

21. The method of claim 19, wherein the biosurfactant, acid, and acidizing additive are applied individually to the formation and mixed in situ.

22. The method of claim 19, further comprising performing an operation after the application of the composition, wherein the operation is fracking, water-based flooding, gas injection and/or thermal injection.

23. (canceled)

24. The method of claim 19, comprising a biosurfactant selected from sophorolipids, rhamnolipids, mannosylerythritol lipids and rhamnolipids.

25-26. (canceled)

27. The method of claim 19, comprising applying:
a solvent or co-solvent selected from glycol ethers, terpenes, terpenoids, acetates, alcohols, kerosene, gasoline, diesel, benzene, toluene, hexane naphtha, cumene, pseudocumene, xylene, water, brine fluids, and produced water;
a surfactant or co-surfactant selected from ethoxylated C12-C16 alcohols, alkylpolyglucosides, sulfonates, disodium oxybis(decylbenzenesulphonate), isopropanolamine dodecylbenzene sulfonate, disodium decyl(sulfonatophenoxy)benzenesulfonate, polyethylene glycol undecyl ether, and propylene glycol;
a chelator selected from EDTA (ethylenediamine tetraacetic acid), HEDTA (hydroxyethylenediamine triacetic acid), nitrilioacetic acid (NTA), erythorbic acid, citric acid, citrate, sodium acetate, glycolic acid, thioglycolic acid, 2-mercaptoethanol, thioglycerol, hypophosphorous acid, inorganics (e.g., copper, antimony, bismuth, iodide) quaternary ammonium compounds, 2-mercaptoethanol, and stannous chloride; and/or
a corrosion inhibitor selected from acetylenic alcohols, organic amines, dimer/trimer acids derived from tall oil or other bases, quaternary amines derived from coconut, canola, tallow, tall oil or other bases, fatty alcohols, derivatized quinolines, alkyl pyridines, and oxyalkylated resin amines.

28-32. (canceled)

33. The method of claim 19, wherein the biosurfactant is in the form of a fermentation broth resulting from cultivation of a biosurfactant-producing microorganism.

34. The method of claim 33, wherein the fermentation broth comprises microbial cells, biosurfactants and other microbial growth by-products, and wherein the microorganism is not active.

35. The method of claim 34, wherein the biosurfactant-producing microorganism is Wickerhamomyces anomalus, Starmerella bombicola, Meyerozyma guilliermondii or Pseudomonas aeruginosa.

36. The method of claim 33, wherein the biosurfactants are further isolated from the fermentation broth.

37. The method of claim 19, further comprising applying a carrier, said carrier comprising water, oil and/or brine fluids.

38. (canceled)

39. The method of claim 19, wherein no iron chelator is applied.
